(19) United States
(12) Patent Application Publication
(10) Pub. No.: US 2021/0380221 A1
(43) Pub. Date: Dec. 9, 2021

(54) CONTINUOUS VARIABLE PITCH ROTOR SYSTEM

(71) Applicant: Bell Textron Inc., Fort Worth, TX (US)

(72) Inventors: Guillaume BIRON, Blainville (CA); Marc OUELLET, Sainte-Sophie (CA); Alexis DUGRÉ, Boisbriand (CA)

(73) Assignee: Bell Textron Inc., Fort Worth, TX (US)

(21) Appl. No.: 16/893,029

(22) Filed: Jun. 4, 2020

(51) Int. Cl. B64C 11/34; B64C 27/39

(52) U.S. Cl. CPC B64C 11/34; B64C 27/39

(57) ABSTRACT

An exemplary continuous variable pitch rotor system includes a blade extending radially from a hub along a longitudinal axis, the blade rotationally coupled to the hub to permit limited rotation of the blade about the longitudinal axis in response to a change in a rotational speed of the hub. In some embodiments, the blade is held in a radially fixed position relative to the hub. In some embodiments, the blade is permitted to translate radially.

### TECHNICAL FIELD

This disclosure relates in general to the field of aircraft, and more particularly, to flight control.

### BACKGROUND

This section provides background information to facilitate a better understanding of the various aspects of the disclosure. It should be understood that the statements in this section of this document are to be read in this light, and not as admissions of prior art.

Rotorcraft rotors are traditionally controlled by varying the revolutions per minute or by varying pitch. Controlling RPM or varying pitch requires compromises to optimize performance in specific flight regimes, i.e., hovering versus forward flight.

### SUMMARY

An exemplary continuous variable pitch rotor system includes a blade extending radially from a hub along a longitudinal axis, the blade is rotationally coupled to the hub to permit limited rotation of the blade about the longitudinal axis in response to a change in a rotational speed of the hub. In some embodiments, the blade is held in a radially fixed position relative to the hub. In some embodiments, the blade is permitted to translate radially.

An exemplary aircraft includes a continuous variable pitch rotor coupled to a fuselage and including a hub rotationally driven by a motor and a blade extending radially from the hub along a longitudinal axis, the blade rotationally coupled to the hub to permit limited rotation of the blade about the longitudinal axis in response to a change in a rotational speed of the hub.

Another exemplary aircraft includes a distributed propulsion system having a plurality of rotors, each of the rotors including a variable speed motor coupled to a hub and a blade extending radially from the hub along a longitudinal axis, the blade rotationally coupled to the hub to permit limited rotation of the blade about the longitudinal axis in response to a change in a rotational speed of the hub.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 illustrates an exemplary aircraft incorporating continuous variable pitch rotor according to aspects of the disclosure.

FIG. 2 illustrates an exemplary aircraft incorporating continuous variable pitch rotor according to aspects of the disclosure.

FIG. 3 illustrates an exemplary ducted continuous variable pitch rotor according to aspects of the disclosure.

FIG. 4 illustrates an exemplary continuous variable pitch rotor where the blade is permitted to rotate relative to a longitudinal axis of the blade in response to a change in rotational speed of the rotor and the blade is held in a radially fixed position.

FIG. 5 illustrates an exemplary continuous variable pitch rotor where the blade is permitted to rotate and radially translate relative to a longitudinal axis of the blade in response to a change in rotational speed of the rotor.

### DETAILED DESCRIPTION

It is to be understood that the following disclosure provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not itself dictate a relationship between the various embodiments and/or configurations discussed.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “inboard,” “outboard,” “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. As used herein, the terms “connect,” “connection,” “connected,” “in connection with,” and “connecting” may be used to mean in direct connection with or in connection with via one or more elements. Similarly, the terms “couple,” “coupling,” and “coupled” may be used to mean directly coupled or coupled via one or more elements.

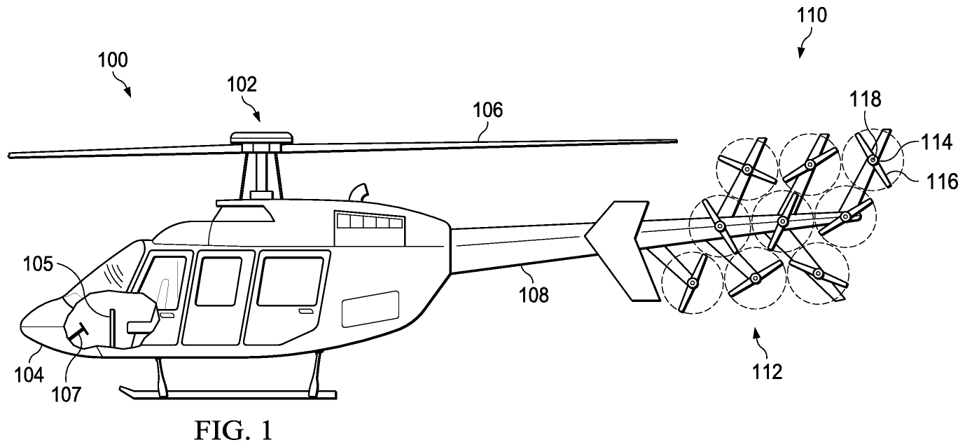

FIG. 1 illustrates an exemplary rotary aircraft 100, shown as a helicopter, having a distributed propulsion system 110 with a plurality of continuous variable pitch rotors 112, i.e., fans, each directly driven by a variable speed motor 114. Distributed propulsion system 110 is illustrated a distributed anti-torque matrix in this example. Motors 114 may be variable speed electric or hydraulic motors. Each rotor or rotor assembly 112 has two or more blades 116 extending radially from a hub 118. Blades 116 are rotationally coupled to hub 118 to permit limited rotation of the blade about the longitudinal axis thereby changing the pitch angle of blades 116 in response to a change in the rotational speed of the hub. Accordingly, output of each rotor 112 can be controlled by varying the blade pitch and the revolutions per minute (RPM) at the same time.

Aircraft 100 includes a main rotary system 102 carried by a fuselage 104. Rotor blades 106 of main rotary system 102 provide flight. Rotor blades 106 may be controlled by multiple controllers within fuselage 104. For example, during flight, a pilot can manipulate controllers 105, 107 for changing a pitch angle of rotor blades 106 and to provide vertical, horizontal and yaw flight control. In some embodiments, main rotary system 102 may be configured as continuous variable rotor system whereby the pitch angle of rotor blades 106 are changed in response to a change in the rotational speed of main rotary system 102. Aircraft 100 has a tail boom 108, which supports distributed propulsion system 110. Each of rotors 112 may be operated individually or in groups. Variable speed motors 114, can be operated individually or in groups at different speeds and in different directions, i.e., positive and negative speed, to provide the required thrust and to avoid or mitigate motor speed dead bands, to avoid yaw authority discontinuity at low rotor RPM, and/or resonant frequency conditions between the rotors and the aircraft structure or the rotor itself, and/or to mitigate tonal frequencies in the acoustic signature of distributed propulsion system 110.

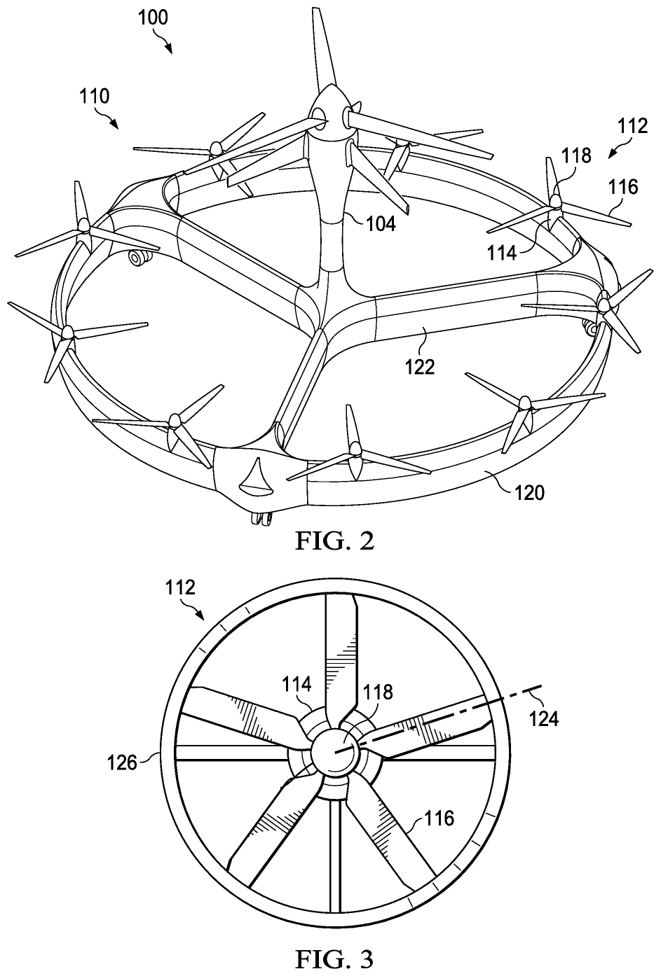

FIG. 2 illustrates another exemplary aircraft 100 having a fuselage 104 surrounded by a closed wing 120 that is coupled to fuselage 104 by spokes 122. Continuous variable pitch rotors 112 are positioned on aircraft 100 in a distributed propulsion system 110. In this example, rotors 112 are open rotors, however the rotors may be ducted. Each rotor is directly driven by a variable speed motor 114 coupled to hub 118. Motors 114 may be variable speed electric or hydraulic motors. Each rotor or rotor assembly 112 has two or more blades 116 extending radially from hub 118. Blades 116 are rotationally coupled to hub 118 to permit limited rotation of the blade about the longitudinal axis, thereby changing the pitch angle of blades 116, in response to a change in the rotational speed of the hub. Accordingly, output of each rotor 112 can be controlled by varying the blade pitch and the revolutions per minute (RPM) at the same time.

FIG. 3 illustrates an exemplary continuous variable pitch rotor 112. Rotor 112 includes hub 118 rotationally driven by a variable speed motor 114. Each rotor or rotor assembly 112 has two or more blades 116 extending radially from hub 118. Blades 116 are rotationally coupled to hub 118 to permit rotation of blade 116 about longitudinal axis 124, thereby changing the pitch angle of blades 116, in response to a change in the rotational speed of the hub. Accordingly, output of each rotor 112 can be controlled by varying the blade pitch and the revolutions per minute (RPM) at the same time. Rotor 112 is enclosed in a duct 126 and blade 116 is radially fixed relative to hub 118.

It should be appreciated that aircrafts 100 are merely illustrative of a variety of aircraft that can implement the embodiments disclosed herein. Indeed, continuous variable pitch rotors 112 may be implemented on any aircraft and distributed propulsion system 110 may be implemented on any aircraft with two or more rotors. Other aircraft implementations can include hybrid aircraft, tiltrotor aircraft, tiltwing aircraft, quad tiltrotor aircraft, unmanned aircraft, gyrocopters, airplanes, helicopters and the like. It should be appreciated that even though aircraft are particularly well suited to implement the embodiments of the present disclosure, non-aircraft vehicles and devices can also implement the embodiments.

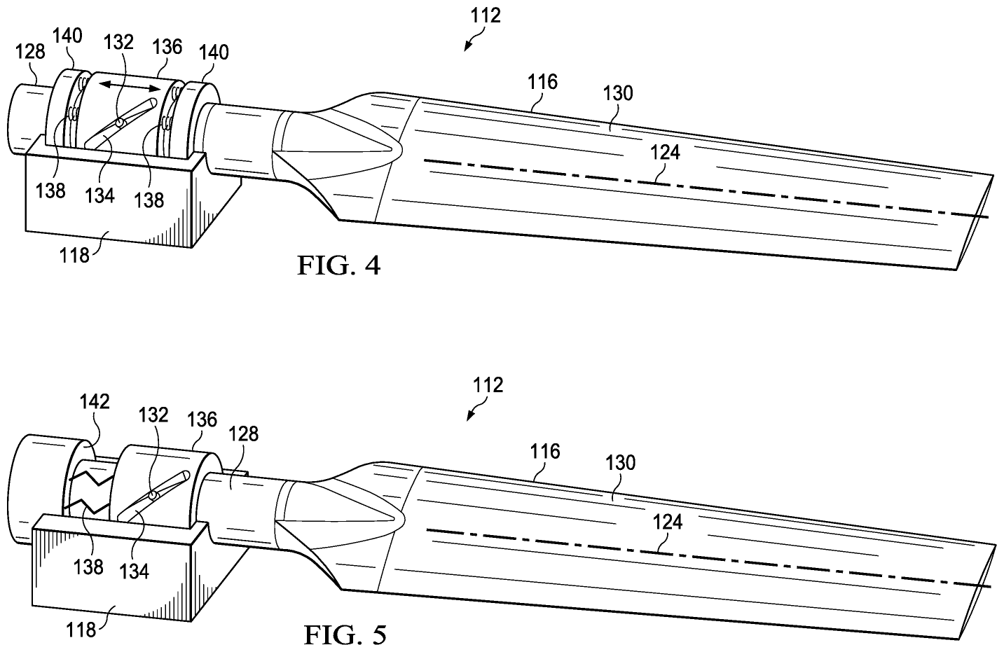

FIGS. 4 and 5 schematically illustrate exemplary continuous variable pitch rotors 112 according to aspects of the disclosure. In some embodiments, such as illustrated in FIG. 4, blade 116 is held in a radially fixed position relative to hub 118. A radially fixed continuous variable pitch rotor 112 is particularly suited for utilization in ducted configurations, for example as shown in FIG. 4. In the exemplary embodiment of FIG. 5, blade 116 is permitted to translate radially as the pitch of blade 116 changes with the changing RPM of hub 118.

Continuous variable pitch rotor system 112 includes a hub 118 and a blade 116 extending radially from hub 118. Blade 116 extends along longitudinal axis 124 from a shaft end 128 through a blade portion 130. Shaft end 128 is rotationally coupled with hub 118 to permit limited rotation of blade 116 about longitudinal axis 124 in response to the change in rotational speed, e.g., RPMs, of hub 118. Accordingly, output of continuous variable pitch rotor system 112 can be controlled by simultaneously changing RPM and blade pitch.

In an example, shaft end 128 is rotationally coupled to hub 118 by a follower 132 and guide 134 arrangement. For example, a follower 132 engaged with a guide 134 in a manner such that relative movement between follower 132 and guide 134 rotates blade 116 relative to longitudinal axis 124. Follower 132 may be disposed with one of shaft end 128 or hub 118 and guide 134, e.g., track, disposed with the other of shaft end 128 or hub 118. In the illustrated example, follower 132 is a pin and guide 134 is a slot or groove. Various structures may be utilized as a follower and guide as will be understood by those skilled in the art with benefit of this disclosure.

With reference to FIG. 4, blade 116 is rotationally coupled to hub 118 and held in a radially fixed position. Thus, blade 116 does not translate radially. In this example, shaft end 128 is rotatably positioned in a block 136 so that blade 116 rotates relative to block 136. Shaft end 128 is rotatably coupled to block 136 through follower 132 and guide 134 arrangement. Block 136 is mounted with hub 118 and rotationally fixed relative to and radially moveable along longitudinal axis 124. One or more springs 138, e.g., tension or compression, may bias block 136 in a radial direction, for example in toward hub 118 to resist the centrifugal force. Spring 138 is not limited to mechanical spring devices. The pitch angle profile, e.g., RPM-pitch relationship, of blade 116 can be controlled with spring stiffness, mass (e.g., blade and/or block), and shape or profile of guide 134. In this example, shaft end 128 is coupled to hub 118 via bearings 140.

With reference to FIG. 5, blade 116 is rotationally coupled to hub 118 and permitted limited radial translation along longitudinal axis 124. A stop 142, such as a shoulder, on shaft end 128 limits the maximum radial translation away from hub 118. Shaft end 128 is rotationally coupled to hub 118 via a follower 132 and guide 134 arrangement. One of the follower 132 or guide 134 is carried by shaft end 128 and is moveable relative to the other one of follower 132 or guide 134 which is carried by hub 118. Because the other one of follower 132 or guide 134 is in a fixed position relative to hub 118 it may be directly connected to hub 118 or directly carried by a block 136 mounted, in a fixed position with hub 118. FIG. 5 illustrates the exemplary embodiment wherein one of the follower or the guide is carried by block 136. Utilizing a block 136 carrying, for example guide 134, allows for changing the RPM-pitch relationship in an aircraft between applications by changing the block. In this example, a spring 138 may be positioned to bias blade 116 in a radial direction, for example toward hub 118.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include such elements or features.

The term “substantially,” “approximately,” and “about” is defined as largely but not necessarily wholly what is specified (and includes what is specified; e.g., substantially 90 degrees includes 90 degrees and substantially parallel includes parallel), as understood by a person of ordinary skill in the art. The extent to which the description may vary will depend on how great a change can be instituted and still have a person of ordinary skill in the art recognized the modified feature as still having the required characteristics and capabilities of the unmodified feature. In general, but subject to the preceding, a numerical value herein that is modified by a word of approximation such as “substantially,” “approximately,” and “about” may vary from the stated value, for example, by 0.1, 0.5, 1, 2, 3, 4, 5, 10, or 15 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure and that they may make various changes, substitutions, and alterations without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A continuous variable pitch rotor system, comprising:
a hub; and
a blade extending radially from the hub along a longitudinal axis, the blade rotationally coupled to the hub to permit limited rotation of the blade about the longitudinal axis in response to a change in a rotational speed of the hub.

2. The continuous variable pitch rotor system of claim 1, wherein the blade is permitted to move radially in response to the change in the rotational speed.

3. The continuous variable pitch rotor system of claim 1, wherein the blade is held in a radially fixed position with the hub.

4. The continuous variable pitch rotor system of claim 1, wherein the blade is rotationally coupled to the hub by a follower engaged with a guide.

5. The continuous variable pitch rotor system of claim 1, wherein the blade is rotationally coupled to the hub by a follower engaged with a guide; and
the blade is held in a radially fixed position with the hub.

6. The continuous variable pitch rotor system of claim 5, further comprising a block mounted with the hub, the block rotationally fixed relative to and radially moveable along the longitudinal axis;
a shaft end of the blade rotatably positioned in the block; and
one of the follower or the guide is carried by the shaft end and the other one of the follower or the guide is carried by the block.

7. The continuous variable pitch rotor system of claim 6, further comprising a spring biasing the block in a radial direction.

8. The continuous variable pitch rotor system of claim 1, wherein the blade is movably coupled to the hub by a follower engaged with a guide; and
one of the follower or the guide is carried by the blade and the other one of the follower or the guide is carried by the hub, wherein the blade is permitted to move radially in response to the change in the rotational speed of the hub.

9. The continuous variable pitch rotor system of claim 8, further comprising a block mounted with the hub in a radially and rotationally fixed position;
a shaft end of the blade rotationally disposed in the block; and
the other one of the follower or the guide is carried by the block.

10. The continuous variable pitch rotor system of claim 8, further comprising a spring biasing the blade in a radial direction.

11. An aircraft comprising:
a fuselage;
a continuous variable pitch rotor coupled to the fuselage, the continuous variable pitch rotor comprising:
a hub rotationally driven by a motor; and
a blade extending radially from the hub along a longitudinal axis, the blade rotationally coupled to the hub to permit limited rotation of the blade about the longitudinal axis in response to a change in a rotational speed of the hub.

12. The aircraft of claim 11, wherein the blade is mounted inside of a duct.

13. The aircraft of claim 11, wherein the blade is held in a radially fixed position with the hub.

14. The claim 11, wherein the blade is rotationally coupled to the hub by a follower engaged with a guide.

15. The claim 11, further comprising a block mounted in the hub, the block rotationally fixed relative to and radially moveable along the longitudinal axis;
a shaft end of the blade rotatably positioned in the block; and
the blade rotationally coupled to the hub by a follower engaged with a guide, wherein one of the follower or the guide is carried by the shaft end and the other one of the follower or the guide is carried by the block.

16. The claim 11, wherein the blade is movably coupled to the hub by a follower engaged with a guide; and
one of the follower or the guide is carried by the blade and the other one of the follower or the guide is carried by the hub, wherein the blade is permitted to move radially in response to the change in the rotational speed of the hub.

17. The claim 16, further comprising a block mounted with the hub in a radially and rotationally fixed position;
a shaft end of the blade rotationally disposed in the block; and
the other one of the follower or the guide is carried by the block.

18. An aircraft comprising:
a distributed propulsion system comprising a plurality of rotors, each of the rotors comprising:
a variable speed motor coupled to a hub; and
a blade extending radially from the hub along a longitudinal axis, the blade rotationally coupled to the hub to permit limited rotation of the blade about the longitudinal axis in response to a change in a rotational speed of the hub.

19. The aircraft of claim 18, wherein the blade is held in a radially fixed position with the hub.

20. The aircraft of claim 18, wherein at least one of the rotors is a ducted rotor and the blade of the ducted rotor is held in a radially fixed position.
